(19) United States
(12) Patent Application Publication
(10) Pub. No.: US 2020/0082011 A1
(43) Pub. Date: Mar. 12, 2020

(54) BIDIRECTIONAL REPLICATION OF CLUSTERED DATA

(71) Applicant: Electronic Arts, Inc., Redwood City, CA (US)

(72) Inventors: Santang Rong, Redwood City, CA (US); Mengxin Ye, Redwood City, CA (US)

(73) Assignee: Electronic Arts, Inc.

(21) Appl. No.: 16/127,978

(22) Filed: Sep. 11, 2018

(51) Int. Cl. G06F 17/30; H04L 29/08

(52) U.S. Cl. CPC G06F 17/30575; H04L 67/1097; G06F 17/30315

(57) ABSTRACT

This disclosure is directed to bidirectional replication of data across two or more data centers where each data center has datastores corresponding to other data centers. When new data is written or updated at a particular data center, that new data may be updated on datastores corresponding to that particular data center at the other data centers. A data center system at the particular data center may indicate to other data center systems at the other data centers that data has been updated along with providing an identity of the particular data center. The other data center systems may update the datastores corresponding with the particular data center with the new data. When data is accessed at a data center, a key indicating the data center of origin may be used to determine the datastore from among a plurality of datastores at a data center in which data is stored.

### BACKGROUND

With the rapid increase of electronic data, data for specific purposes may be stored in multiple datastores that are often geographically distributed. Large repositories of data may introduce problems in data coherency across various geographically distributed storage sites, such as data centers. During use, it may be useful to access data from a data center that is different from a data center where the data was originally stored.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a schematic diagram of an example environment with multiple data centers with each data center having multiple datastores, including datastores associated with other of the data centers, in accordance with example embodiments of the disclosure.

FIG. 2 illustrates a schematic diagram of an example environment where the cross-data center datastores of FIG. 1 are shown in master-slave configurations, in accordance with example embodiments of the disclosure.

FIG. 3 illustrates a flow diagram of an example method by which indications of data written at one data center may be sent to other data centers, in accordance with example embodiments of the disclosure.

FIG. 4 illustrates a chart of an example method by which a datastore at a remote data center is updated based at least in part on the indication of written data as generated by the method depicted in FIG. 3, in accordance with example embodiments of the disclosure.

FIG. 5 illustrates a flow diagram of an example method to read data stored on a datastore at a data center, in accordance with example embodiments of the disclosure.

FIG. 6 illustrates a flow diagram of an example method by which a game play token for playing an online video game may be issued and recorded at a first data center and then accessed later at a second data center, in accordance with example embodiments of the disclosure.

FIG. 7 illustrates a block diagram of example data center system(s) that may provide bidirectional replication and access of data stored at various data centers, in accordance with example embodiments of the disclosure.

### DETAILED DESCRIPTION

Example embodiments of this disclosure describes methods, apparatuses, computer-readable media, and system(s) for providing datastores across two or more data centers, or clusters, such that data that is stored at any one data center may be accessed from any of the other data centers. The datastores may operate according to any suitable database infrastructure, such as REDIS, SQL, or the like. When data is modified at any one data center, those modifications may be replicated at each of the other data centers.

The data centers, according to example embodiments, may include a number of datastores with each datastore corresponding to each of the data centers. When particular data is to be written at a particular data center, data center system(s) at that particular data center may store, save, or otherwise write that particular data to a datastore corresponding to the data center. The data center system(s) at that particular data center may further generate and send an indication of the particular data to other data center(s). Data center system(s) at the other data center(s) may receive the indication of the particular data being stored at the particular data center and store the same data locally in datastores corresponding to the particular data center. In this way, when data is modified (e.g., written, rewritten, deleted, etc.) at a first data center, data stores corresponding to that data center at other data centers are updated.

As disclosed herein, each data center may have a datastore corresponding to itself, as well as to each of the other data centers. When any one of the data centers receive data to be stored, that data may be replicated at all the datastores corresponding to that data center at each of the other data centers. For example, if there are three data centers at Boston, Seattle, and Dallas, then the Boston data center may have a master Boston datastore, a slave Seattle datastore, and a slave Dallas datastore. Similarly, the Seattle data center may have a master Seattle datastore, a slave Boston datastore, and a slave Dallas datastore, and the Dallas data center may have a master Dallas datastore, a slave Boston datastore, and a slave Seattle datastore. If particular data is written to the Boston data center, that particular data may be stored at the master Boston datastore in the Boston data center. Additionally, a data center system at the Boston data center may notify a data center system at the Dallas data center and a data center system at the Seattle data center of the particular data written at the Boston data center. The data center at the Dallas data center may then write the particular data to the slave Boston datastore at the Dallas data center. Similarly, the data center at the Seattle data center may also write the particular data to the slave Boston datastore at the Seattle data center. Thus, any data that is written at any data center may be replicated at each of the other data centers in datastores corresponding to the home data center of the data.

When a data center system at a particular data center notifies other data center system(s) of the data written at that particular data center, the notification may be accompanied with an identity of the particular data center. The data center system(s) at the other data centers may be able to write the incoming data to the datastore corresponding to that data center based at least in part on the identity. In other words, a data center system that receives an indication of new data written at another data center may use an accompanying identifier of the home data center with the indication to determine which one of its datastores on which to write the new data. Referring again to the previous example, when new data may be written to the Dallas data center, the Dallas data center system may send a notification of the new data, along with an identifier of the Dallas data center to each of the Seattle data center system and the Boston data center system. The Boston data center system may determine, based at least in part on the accompanying identifier of the Dallas data center, that the new data is to be stored in a datastore corresponding to the Dallas data center at the Boston data center. Similarly, the Seattle data center system may determine, based at least in part on the accompanying identifier of the Dallas data center, that the new data is to be stored in a datastore corresponding to the Dallas data center at the Seattle data center.

It can be seen, therefore, that whenever any data is stored at a first data center, the data may be replicated at other data centers in datastores corresponding to the first data center. The sorting of the data to its appropriate datastore at a particular data center may be based on the identifier of the originating data center of the data. In this type of configuration, the native datastore (e.g., the Boston datastore at the Boston data center) may be a master datastore, and the Boston datastores at the other data centers (e.g., the Boston datastore at the Dallas data center and the Boston datastore at the Seattle data center) may be slave datastores. Master datastores may be datastores that are originally updated and updates thereto are propagated to slave datastores. In example embodiments of the disclosure, the slave datastores may be geographically separated (e.g., remote) from the master datastore.

In example embodiments, the type of data management may be a key-value database or key-value datastore. In these types of database systems, a key, such as a Redis key, may be used to access stored data. In example embodiments, information about the data center where a particular data is originally stored and from where it is replicated, may be encoded onto the key. Thus, when the key is subsequently used to access the stored data, information about the original data center of the particular data may be determined.

When data needs to be accessed at a particular data center, a request to read the data may be received. This read request may have an associated key, such as in the read request itself and/or received along with the read request. In example embodiments, this key may be a Redis key. As discussed herein, this key may indicate the home data center of the data that is to be read. In this case, the home data center may be the data center where the data was originally stored in a local master datastore. This key may be issued to an entity when the entity writes data at a particular data center. The key may be used during data read operations to identify in which datastore and where in the datastore the data may be stored. For example, if data was originally written to the Seattle data center then an entity associated with that data may receive a key associated with the Seattle data center. When that entity wishes to read, or otherwise access the data, the entity may present the key at any data center to access the data.

A data center, when receiving a read request, may determine from the key which one of its datastores contains the stored data that is to be accessed. For example, if data was written at the Dallas data center by an entity and that entity wishes to access that data from the Seattle data center, then the read request may present a key that indicates the Dallas data center as where the data was originally stored. The Seattle data center system may determine form the key that the data to be read is stored in the Dallas datastore at the Seattle data center. Thus, once the datastore from which the data is to be read is identified at a data center, the data can be read and/or used.

The mechanisms discussed herein may replicate, such as in a bidirectional manner, data between data centers. The data, as written to one data center, can be replicated in all of the other data centers that may be associated with a particular entity (e.g., company). Each data center, therefore, may be updated to have data at each of the other data centers. The local datastore at any data center may be a master datastore, and the corresponding replicated datastores at the other data centers may be the slave datastores. Additionally, any data written at any one data center may be accessed at any other data center.

The bidirectional replication mechanism, as described herein, may be used in a variety of applications. For example, the mechanism disclosed herein may allow for redundancy and backup of data across data centers. If one data center is inaccessible, data can still be accessed from other data centers even if the data was not originally written at those other data centers. Thus, the mechanisms disclosed herein allow for redundancy, data integrity, disaster recovery, and operations during failure states. This technological improvement in computer data storage and management allows greater uptime, greater access to data, and thus, better user experiences. The technological improvements further include not losing, or at least minimizing, stored data. Without the bidirectional replication, as discussed herein, it may be difficult to recover from a disaster situation and/or enable continuous operations when one or more data centers are not operational. This is because bidirectional replication allows for copy exact of data stored at one data center at the other data centers.

It should further be understood that the writing and reading of data from the collection of data centers can be load balanced. For example, read/write traffic may be directed away from a data center that has a particularly high level of activity. This way, system-wide latency for read/write access may be reduced and network and/or processing bandwidth may be balanced across data centers. Additionally, an entity's data may be brought closer to that entity. It should be appreciated that this type of geographical load balancing is not achieved by unidirectional replication. Thus, the bidirectional replication with key encoding allows for more efficient use of computing resources and network bandwidth. The computing and data management technological improvements as disclosed herein, therefore, allows for improvements in computing efficiency, computer resource deployment, and network efficiency, along with reduced latency in accessing data. Without bidirectional replication across the data centers load balancing and improved geographical proximity may not be possible.

An example implementation of the improved datastore technology, as discussed herein, may be in the realm of online video gaming. This application may involve the issuance of tokens that allow access to an online video game. The game play token may be issued at one data center, but a user may wish to access and/or use the game play token at another data center to gain access to an online game. The bidirectional replication, such as of the issued game play token, may enable the user to use his or her game play token from any data center affiliated with the data center where his or her game play token was issued. This is just one example of implementation of the bidirectional replication technology as disclosed herein, and there may be a variety of applications of this type of database structure and management.

Certain implementations and embodiments of the disclosure will now be described more fully below with reference to the accompanying figures, in which various aspects are shown. However, the various aspects may be implemented in many different forms and should not be construed as limited to the implementations set forth herein. It will be appreciated that the disclosure encompasses variations of the embodiments, as described herein. Like numbers refer to like elements throughout.

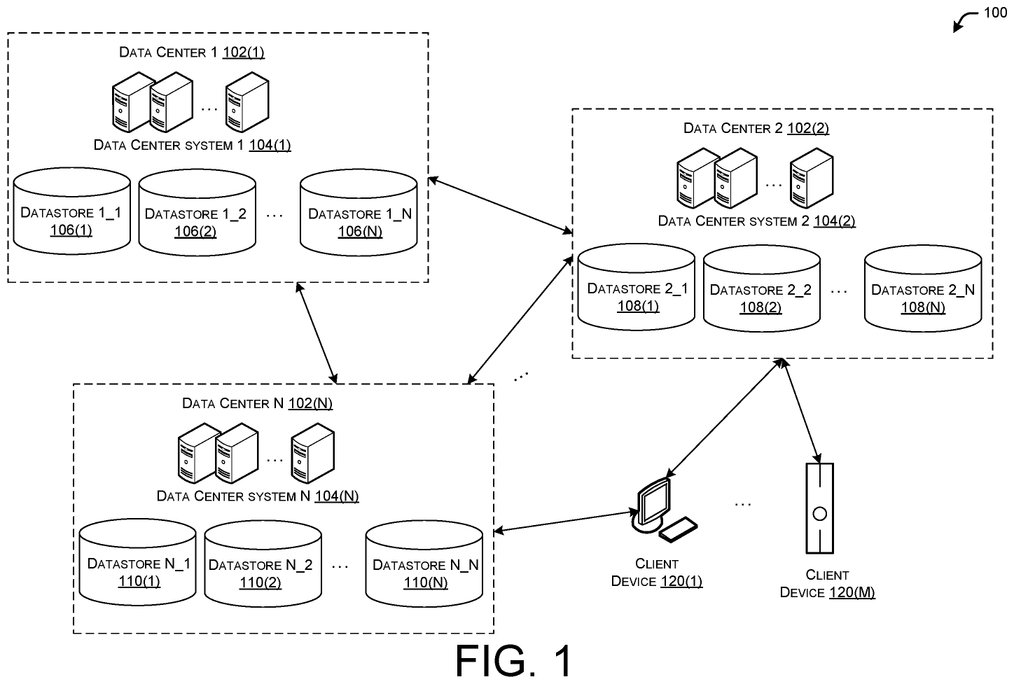

FIG. 1 illustrates a schematic diagram of an example environment 100 with multiple data centers 102(1), 102(2), . . . , 102(N) with each data center 102(1), 102(2), . . . , 102(N), having multiple datastores 106(1), 106(2), . . . , 106(N), 108(1), 108(2), . . . , 108(N), 110(1), 110(2), . . . , 110(N), including datastores associated with other of the data centers 102(1), 102(2), . . . , 102(N), in accordance with example embodiments of the disclosure.

The data centers 102(1), 102(2), . . . , 102(N), hereinafter referred to collectively or individually as data center(s) 102 or data center 102, may be geographically distributed. For example, an entity such as a corporation that conducts business world-wide may wish to locate data centers in multiple locations around the world. This may allow the entities customers and/or employees to access data from a data center 102 that is relatively proximate to the customer and/or employee. These data centers may be communicatively connected to each other, such as via data center systems 104(1), 104(2), . . . , 104(N), hereinafter referred to collectively or individually as data center system(s) 104 or data center system 104. Each of the data centers may also include a variety of datastores 106(1), 106(2), . . . , 106(N), 108(1), 108(2), . . . , 108(N), 110(1), 110(2), . . . , 110(N).

The first data center 102(1) may have datastores 106(1), 106(2), . . . , 106(N), hereinafter referred to collectively or individually as datastore(s) 106 or datastore 106. Similarly, the second data center 102(2) may have datastores 108(1), 108(2), . . . , 108(N), hereinafter referred to collectively or individually as datastore(s) 108 or datastore 108. Each data center may be organized in a similar way to the last data center 102(N) which may have datastores 110(1), 110(2), . . . , 110(N), hereinafter referred to collectively or individually as datastore(s) 110 or datastore 110.

When data is to be written at a particular data center 102, the data may be received by and/or generated by the corresponding data center system 104. For example, when data is to be stored at the first data center 102(1), the data to be written may be received by, such as from an external entity, and/or generated by the first data center system 104(1). Similarly, when data is to be accessed at a particular data center 102, a request to read the data may be received by the corresponding data center system 104. For example, if data is to be read at the second data center 102(2), a request to read the data may be received at the corresponding data center system 104(2).

In some embodiments, the data center systems 104 may be a database management system (DBMS) implemented as a database application operating on a computing system. The DBMS may be of any suitable format, such as Remote Dictionary Server (Redis), MongoDB, Structured Query Language (SQL), any variety of Non-SQL (NoSQL), Open Database Connectivity (ODBC), Java Database Connectivity (JDBC), or the like. In example embodiments, the data center systems 104 may operate a key-value database or key-value datastore, where a key may be used to uniquely identify a recorded data within the database. In other words, the key in a key-value datastore may be a pointer to data within a datastore. For example, the data center system 104 may be a Redis DBMS system using key-value database technology with a Redis key. In these embodiments, the data may be of abstract format, without predefined fields, as may exist in a relational database (RDB). In example embodiments, the key associated with and used to access a particular data may also indicate the home data center of the particular data, or otherwise the data center where the data write request was received. In some cases, there may be more than one key and/or the key maybe a composite key.

The data center systems 104, in example embodiments, may be standalone DBMS systems. In other example embodiments, the data center systems 104 may be a part of other system(s) such as online gaming systems that issue and/or verify game playing/access tokens and also stores the game tokens. The online gaming system is just an example of a larger system. Indeed, the data center systems 104 may be part of any other application-specific system.

The datastores 106, 108, 110 may be any suitable type of data storage devices to which the data center systems 104 are able to write and/or read data. The datastores 106, 108, 110 may be any suitable non-volatile and/or volatile datastores. In some cases, the datastores 106, 108, 110, as depicted here, may be a collection of datastore devices of the same or different types. The datastores 106, 108, 110 may use any one of or a combination of storage mechanism, such as semiconductor storage, magnetic storage, optical storage, combinations thereof, or the like. The datastores 106, 108, 110 may include hard disk drives (HDD), solid state disk drives (SSD), optical drives, tape drives, random access memory (RAM), read only memory (ROM), combinations thereof, or the like.

The environment 100 may further include client device 120(1), . . . , 120(M), hereinafter referred to in collectively or individually as client device(s) 120 or client device 120. The client device 120 may be any suitable entity that may be communicatively linked, such as by a communications network, to one or more data centers 102. The client devices 120 may be entities that can request storing data at a data center and/or read data from a data center. In some applications, such as online gaming applications, the client devices may be gaming consoles, of devices on which a user may play one or more online video games.

Within the first data center 102(1), the datastore 1_1 106(1) may be the local datastore for the first data center 102(1) and may be a master datastore to slave datastore 2_1 108(1) of data center 102(2) and slave datastore N_1 110(1) of data center 102(N). When data is to be written at the first data center 102(1), the first data center system 104(1) may write the data to datastore 1_1 106(1) and issue a key to access the stored data. This key may allow finding the stored data on the datastore 1_1 106(1). The key, according to example embodiments, may further include an indication of the first data center 102(1). This indication, for example, may be a unique identifier of any one of the first data center 102(1), the first data center system 104(1), and/or the datastore 1_1 106(1). The key may be provided to an entity on behalf of which the data may have been stored. That entity would be able to access the data in the future using the key.

The first data center system 104(1), after writing the data, may further send an indication of the data to data center systems 104(2), 104(N). This indication may be the data written on the local datastore 1_1 106(1) along with an identifier of the first data center 102(1). In some cases, this identifier of the first data center 102(1) may be the same as, or substantially similar to, the indication of the first data center, as was incorporated into the key that was generated upon writing the data to the local datastore 1_1 106(1). This identifier may be a unique identifier of any one of the first data center 102(1), the first data center system 104(1), and/or the datastore 1_1 106(1). When data center system 104(2) receives the indication of the stored data, it may determine that the indication of the stored data came from the first data center 102(1). It may then store the data in datastore 2_1 108(1), or the datastore at the second data center 102(2) that corresponds to the first data center 102(1). The datastore 2_1 108(1) may be a slave datastore to master datastore 1_1 106(1). Similarly, when data center system 104(N) receives the indication of the stored data, it may store the data in datastore N_1 110(1). The datastore N_1 110(1) may be a slave datastore to master datastore 1_1 106(1). Although this replication mechanism is described in the context of three data centers 102, it should be understood that this mechanism may apply to any number of separate data centers 102. In other words, there may be any number of slave datastores corresponding to master datastore 1_1 106(1).

In example embodiments, the replication from a master datastore, such as datastore 1_1 106(1), datastore 2_2 108(2), and datastore N_N 110(N), to their corresponding slave datastores 108(1), 110(1), 106(2), 110(2), 106(N), 108(N) may be synchronous, nearly synchronous, or asynchronous. When the replication is asynchronous, there may be a lag in the coherency between the master and slave datastores for certain periods of time. In some cases, the coherency lag may be engineered based at least in part on a trade-off between network bandwidth requirements and potential data access misses. In example embodiments, the corresponding datastores 106, 108, 110 across the various data centers 102 may be replicated exactly except for relatively short predetermined time periods (e.g., update lags) during which the updating occurs.

The data center systems 104 may further be able to access or read the data stored at its respective data center 102 across any one of its datastores 106, 108, 110. A request for access to data may be received from any suitable entity. This request may include a key corresponding to the data to be accessed. This key, as described herein, may incorporate an indication of the data center 102 where the data was originally stored. This key may have been provided earlier by the data center system 104 when data was written to a datastore 106, 108, 110. The key, according to example embodiments, may not only serve as a pointer to where the data may be saved, but also indicate to the data center system 104 receiving the data access request of which datastore 106, 108, 110 in its data center 102 might store the requested data.

The data center system 104 receiving a request for data access may determine from the key an identity of which data center 102 originally stored the data being requested. The data center system 104 may then identify which of its datastores 106, 108, 110 corresponds to that data center 102, and access the data from the identified datastore 106, 108, 110. The data center system 104 may then provide the requested data to the requesting entity. The requesting entity may be any suitable entity, such as the entity that originally requested storing the data and/or any other entity that is permissioned to use the data. In some example embodiments, the data may be a game access token, and the requesting entity may be any online gaming system and or console gaming system that may use the game access token to conduct an online video game.

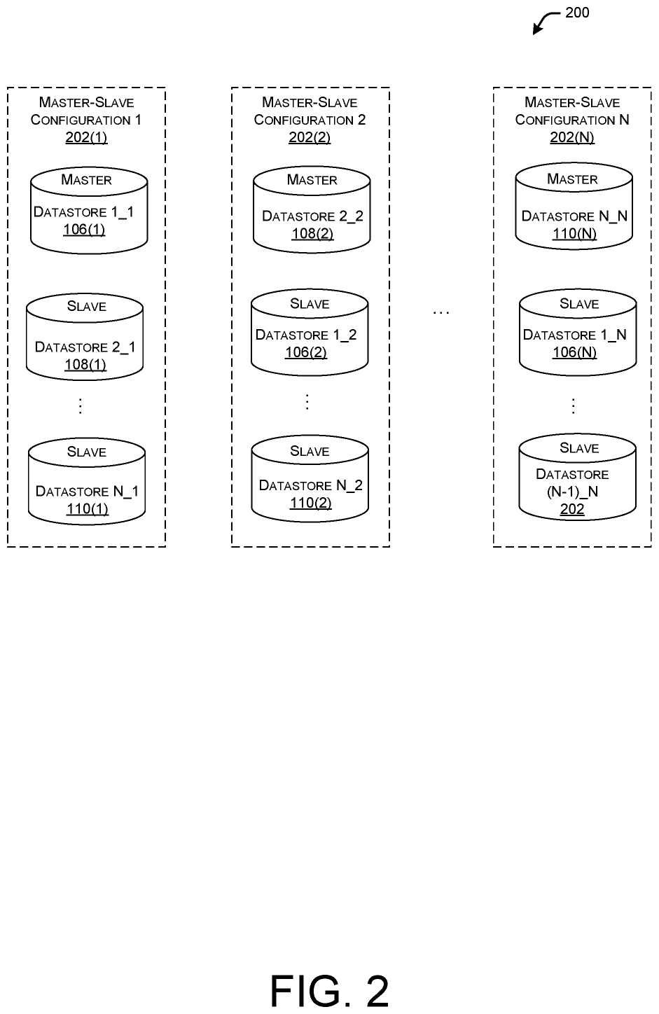

FIG. 2 illustrates a schematic diagram of an example environment 200 where the cross-data center datastores of FIG. 1 are shown in master-slave configurations 202(1), 202(2), . . . , 202(N), in accordance with example embodiments of the disclosure. The master-slave configurations 202(1), 202(2), . . . , 202(N), referred to hereinafter in combination or individually as master-slave configuration 202, may be an abstraction for the purposes of visualization. In other words, the master datastores 106, 108, 110 are not co-located with their corresponding slave datastores 106, 108, 110. In fact, for the purposes of bidirectional replication, the slave datastores 106, 108, 110 are located at a different data center than their corresponding master datastore 106, 108, 110.

As shown, in a master-slave configuration, the datastore 1_1 106(1) may be a master to slave datastore 2_1 108(1) and slave datastore N_1 110(1). Another master-slave configuration may have the datastore 2_2 108(2) as the master datastore to slave datastore 1_2 108(2) and slave datastore N_2 110(2). Similarly, the datastore N_N 110(N) may be the master datastore to slave datastore 1_N 106(N) and slave datastore (N−1)_N 202. It should be noted that in the situation where there are 3 data centers 102 (i.e., N=3), then slave datastore (N−1) N 202 would be slave datastore 2_N 108(N).

It should be understood that the indexes used herein are an example, and any other mechanism may be used to index the system-wide datastores according to example embodiments of the disclosure. For example, referencing the example from earlier with the data centers at Boston, Seattle and Dallas, the datastore Boston_Boston may be a master datastore located in Boston data center to slave datastore Seattle_Boston located in Seattle data center and datastore Dallas_Boston located in Dallas.

The master datastores may be where data is written to first and then the data may be replicated from the master datastore to the slave datastores, as described herein. It should be noted that if there is an N number of data centers 102, then at each data center, there may be a N different datastores 106, 108, 110 corresponding to each of the data centers 102. Of the N different datastores 106, 108, 110 at each data center 102 one datastore 106, 108, 110 may be a master datastore 106, 108, 110 that corresponds to its data center 102. The other N−1 datastores 106, 108, 110 at each data center 102 may be slave datastores 106, 108, 110 that are replicated to match master datastores 106, 108, 110 at the other data centers 102.

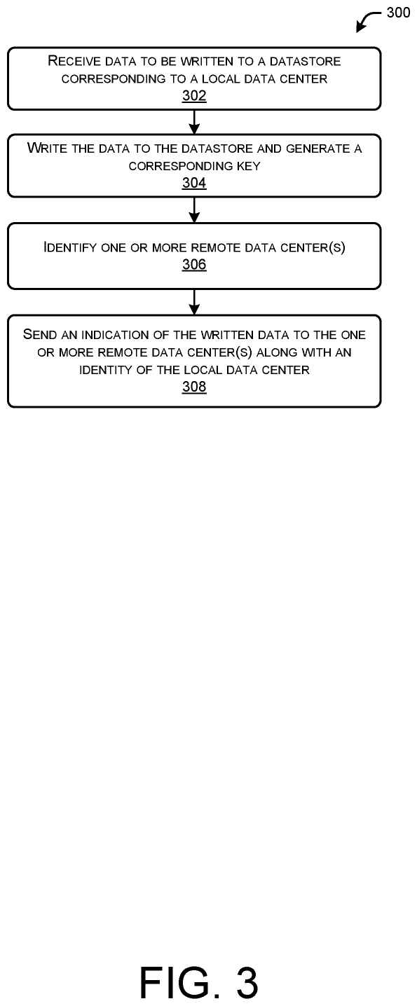

FIG. 3 illustrates a flow diagram of an example method 300 by which indications of data written at one data center may be sent to other data centers, in accordance with example embodiments of the disclosure. The method 300 may be performed by the data center system 104, individually or in cooperation with one or more other elements of the environment 100.

At block 302, data to be written to a datastore corresponding to a local data center may be received. In other words, the data center system 104 of the local data center 102 may receive the data to be written to the datastore 106, 108, 110 that is local to that data center 102. This datastore 106, 108, 110 may be a master to corresponding slave datastores 106, 108, 110 at other data centers 102. As an example, data received at the second data center 102(2) by data center system 104(2) of FIG. 1 would have datastore 2_2 108(2) as the local datastore of the second data center 102(2).

At block 304, the data may be written to the datastore and an access key corresponding to the data may be generated. While writing the data to the datastore 106, 108, 110, the key may be generated. The key, in example embodiments, may be a Redis key that serves as a pointer to the data stored to the datastore 106, 108, 110. According to example embodiments, the key may include an identifier of the local data center. The key, in example embodiments, may be provided to an entity that requested storing the data. In other cases, the key may be stored by the data center system 104 to later access the stored data. Although discussed in the context of a single access key, in some example embodiments, there may be more than one access key and/or the access key may be a compound key.

At block 306, one or more remote data center(s) may be identified. These remote data centers 102 may be affiliated (e.g., belong to or controlled by the same entity). Each of the data center systems 104, in example embodiments, may have a listing of other data center systems 104 and/or their data centers 102 within their combined data center footprint.

At block 308, an indication of the written data may be sent to the one or more remote data center(s) along with an identity of the local data center. This indication may include the data that has been written so that it can be replicated at the remote data center(s) 102. The identity of the local center may be any suitable indicator of the local data center, such as a unique identifier of the data center 102, a unique identifier of the associated data center system 104, and/or a unique identifier of the associated datastore 106, 108, 110 at the data center 102. The identifier of the data center 102 allows the remote data center system(s) 104 at the remote data center(s) 102 to replicate the data to the correct datastore 106, 108, 110 at the remote data center(s) 102.

It should be noted that some of the operations of method 300 may be performed out of the order presented, with additional elements, and/or without some elements. Some of the operations of method 300 may further take place substantially concurrently and, therefore, may conclude in an order different from the order of operations shown above.

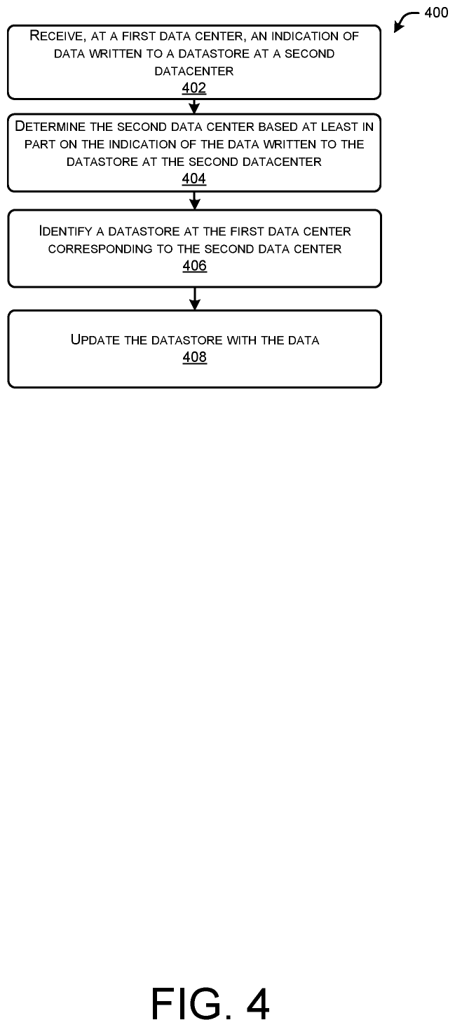

FIG. 4 illustrates a chart of an example method 400 by which a datastore 106, 108, 110 at a remote data center 102 is updated based at least in part on the indication of written data as generated by the method 300 depicted in FIG. 3, in accordance with example embodiments of the disclosure. The method 400 may be performed by the data center system 104 at a remote data center 102, individually or in cooperation with one or more other elements of the environment 100.

At block 402, at a first data center, an indication of data written at a second data center maybe received. In this context, the first data center may be a remote data center 102 and the second data center 102 may be the original data center where the data was written to a local (e.g., master) datastore 106, 108, 110. The indication of the data written at the second data center 102 may include the data itself, as well as an identifier of the second data center 102. In other words, after a second data center system 104 stored the data locally at the second data center 102, the indication of that data may be sent by the second data center system 104 to the first data center system 104 at the first data center 102.

At block 404, the second data center may be determined based at least in part on the indication of the data written to the datastore at the second data center. The identifier, as incorporated in the indication of the data written to the datastore 106, 108, 110 at the second data center 102, may indicate to the data center system 104 of the first data center 102 that the originating data center is the second data center 102.

At block 406, a datastore at the first data center corresponding to the second data center may be identified. This may be a slave datastore 106, 108, 110 to the master datastore 106, 108, 110 on which the data was written at the second data center 102.

At block 408, the datastore may be updated with the data. This datastore 106, 108, 110 that replicates the master datastore 106, 108, 110 at the second data center 102 may now be updated with the data. Thus, this datastore 106, 108, 110 at the first data center 102 may now be an exact copy, in example embodiments, of the master datastore 106, 108, 110 at the second data center 102.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

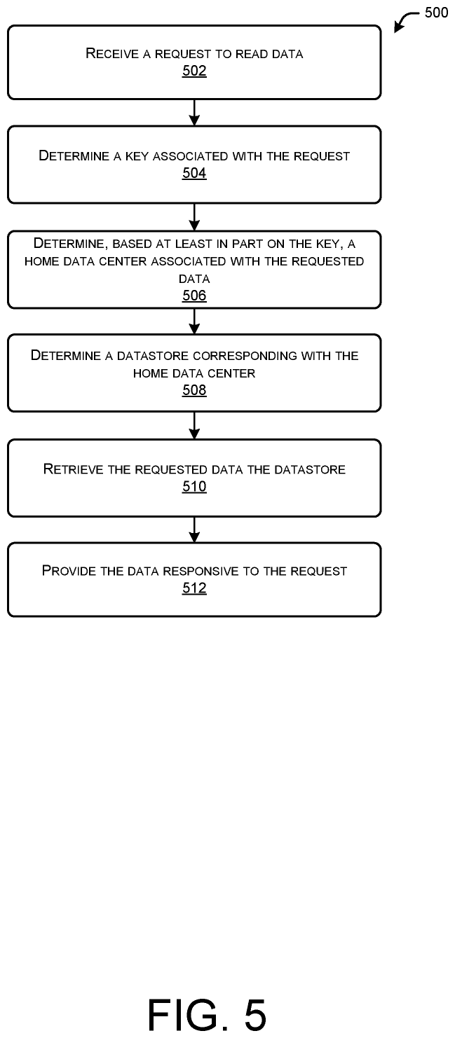

FIG. 5 illustrates a flow diagram of an example method 500 to read data stored on a datastore 106, 108, 110 at a data center 102, in accordance with example embodiments of the disclosure. The method 500 may be performed by a data center system 104, individually or in cooperation with one or more other elements of environment 100.

At block 502, a request to read data may be received. This request may be received by the data center system 104 at the data center 102. This request may be received from any suitable entity authorized to access the data being requested. At block 504, a key associated with the request may be determined. The key may be incorporated within the request itself. In some example embodiments, the key may be a Redis key, or any other suitable key-value database key, that acts as a pointer within a datastore 106, 108, 110 for locating the data. According to example embodiments, the key may further include information about the data center 102 where the requested data was originally stored. This may be the home data center 102 of the requested data.

At block 506, the home data center associated with the requested data may be determined based at least in part on the key. This home data center's identity may be incorporated onto the key, such as by the operations of method 300 of FIG. 3. The home data center 102, as discussed herein, may be the data center 102 where the requested data was originally stored. In some cases, this home data center 102 may be the same data center 102 where the data is request, and in other cases, the data center 102 where the data is requested may be different from the home data center 102.

At block 508, a datastore corresponding to the home data center may be determined. Individual data store systems 104 may be aware, such as by way of a look-up table, a correspondence of data centers 102 to its datastores 106, 108, 110. At block 510, the requested data may be retrieved from the datastore. The key may be used to locate the data within the datastore 106, 108, 110. At block 512, the data maybe provided responsive to the request for the data. The data may be provided to an entity that requested the data.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

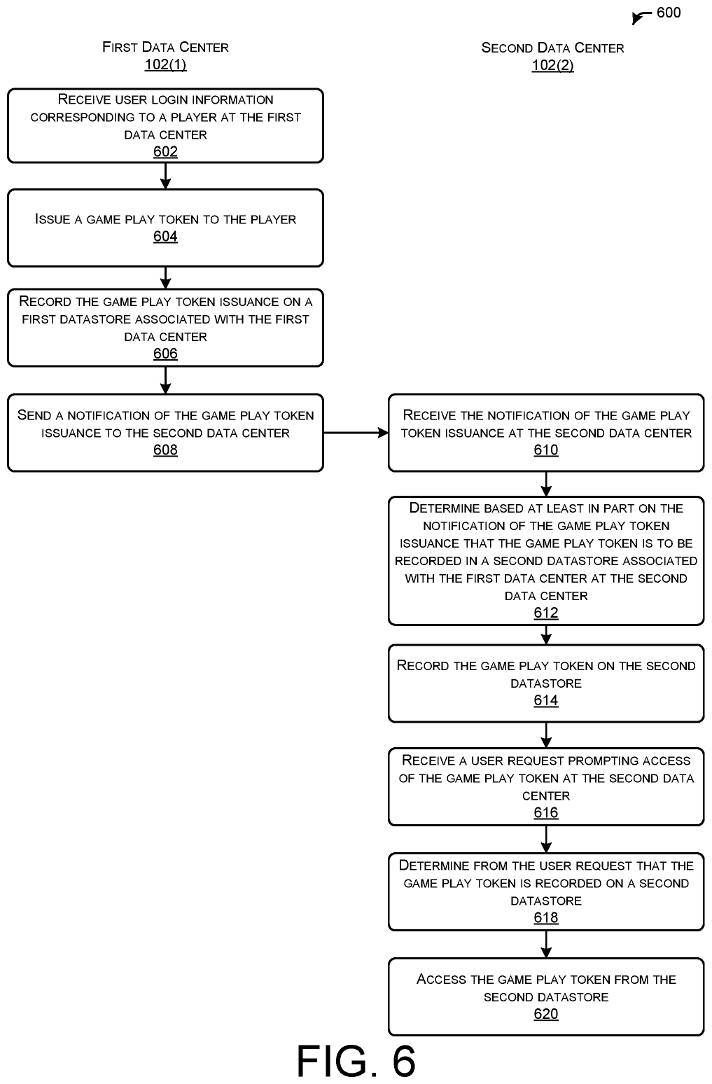

FIG. 6 illustrates a flow diagram of an example method 600 by which a game play token for playing an online video game may be issued and recorded at a first data center 102(1) and then accessed later at a second data center 102(2), in accordance with example embodiments of the disclosure. This method may be performed by entities (e.g., data center system(s) 104, datastores 106, etc.) at a first data center 102(1) and entities at a second data center 102(2).

The method 600 may also be performed in conjunction with a game client device 120 that may engage in online gaming. This game client device 120 may be a video game console and/or other computing device via which a user may play on online video game. Accessing such a video game may entail presenting and/or validating a game token that may be issued, stored, and/or accessed at one or more data centers 102. Example game client devices may be any suitable device, including, but not limited to a Sony Playstation® line of systems, a Nintendo Wii® line of systems, a Microsoft Xbox® line of systems, any gaming device manufactured by Sony, Microsoft, Nintendo, or Sega, an Intel-Architecture (IA)® based system, an Apple Macintosh® system, a netbook computer, a notebook computer, a desktop computer system, a set-top box system, a handheld system, a smartphone, a personal digital assistant, combinations thereof, or the like.

At block 602, user login information corresponding to a player may be received at a first data center. This user login information may be authentication credentials of the player that may be used to login and/or otherwise gain access to a game play token for online gaming. The login information may be checked to determine if the player is authorized to play the game that he or she wishes to play to determine that a game play token is to be issued.

At block 604, a game play token may be issued to the player. This may be issued after checking the player's authentication credentials as received as his or her login information. This game play token may enable the player to play an online video game, such as with other players. The player may access the online video game using his or her game client device and by having the issued game play token.

At block 606, the game play token issuance may be recorded on a first datastore associated with the first data center. In this case, the game play token may be data that is recorded at the first data center 102(1). It should be understood that in some cases, the data center system 104 of the first data center 102(1) may also be the issuing entity of the game play token. In other words, the data center system 104 may both issue game play tokens and operate as DBMS at the first data center 102(1). The first data datastore 106(1) may be the master datastore at the first data center 102(1).

At block 608, a notification may be sent of the game play token issuance to the second data center. This notification, as described herein, may include the recordation of the game play token. The notification may further include an identifier of the first data center 102(1). In this way, the data center system 104(2) of the second data center 102(2) will have information pertaining to where the notification originated, namely the first data center 102(1). At block 610, the notification of the game play token issuance maybe received at the second data center. Thus, the data center system 104(2) of the second data center 102(2) may have information pertaining to what was recorded at the first data center 102(1), as well as that the recordation was at the first data center 102(1).

At block 612, it may be determined that the issuance of the game play token is to be recorded in a second datastore associated with the first data center and located at the second data center. The second datastore 108(1) may be identified as the datastore 108 that corresponds to the first data center 102(1). At block 614, the game play token may be recorded on the second datastore. This may be in response to the second data center system 104(2) receiving the indication of the recordation of the game play token at the first data center 102(1). Upon recordation, the game play token may be accessed at the second data center 102(2) in addition to the first data center 102(1). Although not discussed here, it should be understood that the game play token recordation may be replicated at additional data centers 102.

At block 616, a user request prompting access of the game play token at the second data center may be received. This access may be for the purposes of the player playing an online video game. The request for access to the game play token may be directed to the second data center 102(2), rather than the first data center 102(1), for any variety of suitable reasons. For example, the player may have moved to a location that is now closer to the second data center 102(2), rather than the first data center 102(1). Other reasons that may prompt the request for access from the second data center 102(2) may include the first data center 102(1) being unavailable and/or load balancing away from the first data center 102(1) due to heavy use of the first data center 102(1).

At block 618, it may be determined from the user request that the game token is recorded on the second datastore. The request may include the key that was generated as a pointer to the requested record. This key, as discussed herein, may include an indication of the original or home data center as the first data center 102(1). As a result, from the request, the data center system 104(2) at the second data center 104(2) may be able to identify the home data center identifier and determine therefrom that the record is stored in a second datastore 108(1) at the second data center 102(2).

At block 620, the game play token may be accessed from the second datastore. The key may provide a pointer to the location within the second datastore 108(1) where the game play token is stored. Once the game play token is retrieved, it may be passed onto a game client device, an online gaming host server, or any other suitable entity that may use the game play token to provide the user with access to an online video game.

It is seen here that even though a game play token was recorded at one data center 102, its record was replicated at another data center 102. As a result, the game play token could be accessed at a later time from a different data center 102 from which it originated. This may have several advantages, such as data redundancy, robust data backup, network load balancing, and/or storage location balancing. Although an application related to online gaming is discussed herein, it should be understood that the bidirectional replication of clustered data may have a variety of different applications in a variety of different fields.

It should be noted that some of the operations of method 600 may be performed out of the order presented, with additional elements, and/or without some elements. Some of the operations of method 600 may further take place substantially concurrently and, therefore, may conclude in an order different from the order of operations shown above.

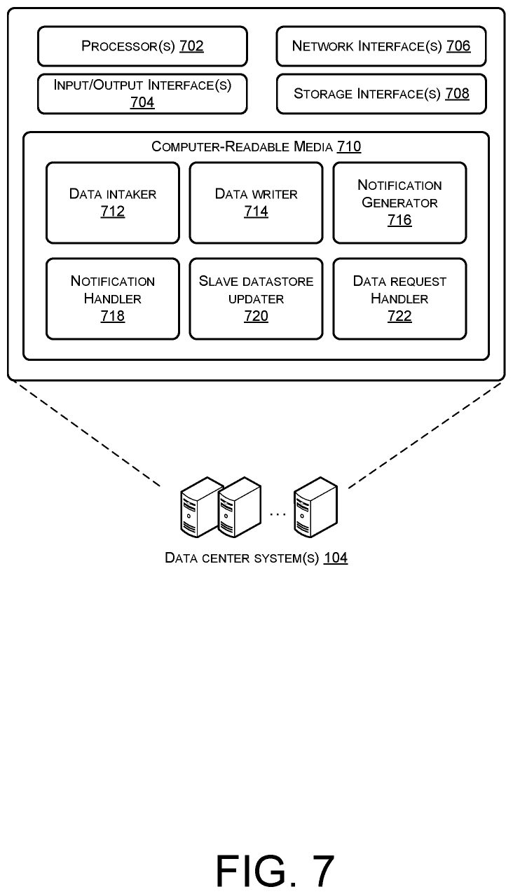

FIG. 7 illustrates a block diagram of example data center system(s) 104 that may provide bidirectional replication and access of data stored at various data centers, in accordance with example embodiments of the disclosure.

The data center system(s) 104 may include one or more processor(s) 702, one or more input/output (I/O) interface(s) 704, one or more network interface(s) 706, one or more storage interface(s) 706, and computer-readable media 710.

In some implementations, the processors(s) 702 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip system(s) (SOCs), complex programmable logic devices (CPLDs), etc. Additionally, each of the processor(s) 700 may possess its own local memory, which also may store program modules, program data, and/or one or more operating system(s). The one or more processor(s) 700 may include one or more cores.

The one or more input/output (I/O) interface(s) 702 may enable the data center system(s) 104 to detect interaction with a user and/or other system(s), such as one or more entities that wish to store or access data. The I/O interface(s) 702 may include a combination of hardware, software, and/or firmware and may include software drivers for enabling the operation of any variety of I/O device(s) integrated on the data center system(s) 104 or with which the data center system(s) 104 interacts, such as displays, microphones, speakers, cameras, switches, and any other variety of sensors, or the like.

The network interface(s) 706 may enable the data center system(s) 104 to communicate via the one or more network(s). The communications interface(s) 706 may include a combination of hardware, software, and/or firmware and may include software drivers for enabling any variety of protocol-based communications, and any variety of wireline and/or wireless ports/antennas. For example, the network interface(s) 706 may comprise one or more of a cellular radio, a wireless (e.g., IEEE 802.1x-based) interface, a Bluetooth® interface, and the like. In some embodiments, the network interface(s) 706 may include radio frequency (RF) circuitry that allows the data center system(s) 104 to transition between various standards. The network interface(s) 706 may further enable the data center system(s) 104 to communicate over circuit-switch domains and/or packet-switch domains.

The storage interface(s) 708 may enable the processor(s) 702 to interface and exchange data with the computer-readable medium 710, as well as any storage device(s) external to the data center system(s) 104, such as the datastores 106, 108, 110.

The computer-readable media 710 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage system(s), or any other medium which can be used to store the desired information and which can be accessed by a computing device. The computer-readable media 710 may be implemented as computer-readable storage media (CRSM), which may be any available physical media accessible by the processor(s) 702 to execute instructions stored on the memory 710. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information and which can be accessed by the processor(s) 702. The computer-readable media 710 may have an operating system (OS) and/or a variety of suitable applications stored thereon. The OS, when executed by the processor(s) 702 may enable management of hardware and/or software resources of the data center system(s) 104.

Several functional blocks having instruction, data stores, and so forth may be stored within the computer-readable media 710 and configured to execute on the processor(s) 702. The computer readable media 710 may have stored thereon a data intaker 712, a data writer 714, a notification generator 716, a notification handler 718, a slave datastore updater 720, and a data request handler 722. It will be appreciated that each of the functional blocks 712, 714, 716, 718, 720, 722, may have instructions stored thereon that when executed by the processor(s) 702 may enable various functions pertaining to the operations of the data center system(s) 104.

The instructions stored in the data intaker 712, when executed by the processor(s) 702, may configure the data center system(s) 104 to receive data from one or more other entities. These entities may include any variety of other devices, such as personal computing devices, corporate devices, other data centers, gaming consoles, or the like. The data intaker 712 may have instructions thereon that when executed by the processor(s) 702 may enable the data center system(s) 104 to determine whether a certain entity is authorized to store and/or access data at the data center 102. This may involve, in example embodiments, the use of authentication credentials in interacting with the data center systems 104.

The instructions stored in the data writer 714, when executed by the processor(s) 702, may configure the data center system(s) 104 to write data to a local datastore 106, 108, 110 at a given data center 102. This may entail identifying the master datastore 106, 108, 110 at the data center 102 and then writing the data to that datastore. Upon writing the data, a key may be generated, such as a Redis key. The key may be a pointer to where in the master datastore 106, 108, 110 of the data center 102 the data is stored. Additionally, according to example embodiments of the disclosure, the key may encode an identifier of the data center 102 thereon. In other words, the data center system 104 may encode an identifier of its data center 102 onto the key, so that whenever the key is presented to access the data, regardless of which data center the key is presented, the original data center, or here the data was originally stored, can be determined. Thus, other data center system(s) 104 may be able to use the key to determine the data center where the data was stored on a master datastore 106, 108, 110, rather than a slave datastore 106, 108, 110.

The instructions stored in the notification generator 716, when executed by the processor(s) 702, may configure the data center system(s) 104 to generate a notification when data has been stored at its data center 102. When data is stored on to a master datastore 106, 108, 110 at a data center 102, the storage of that data may be communicated to the data center systems 104 all of the other data centers 102. In this way, the data center systems 104 of the other data centers 102 may update their slave datastores 106, 108, 110 to replicate the master datastore of the home data center 102. In example embodiments, the notification may include an identifier of the home data center 102. In this way, the other data center systems 104 can determine which one of the slave datastores 106, 108, 110 to update at their data centers 102.

The instructions stored in the notification handler 718, when executed by the processor(s) 702, may configure the data center system(s) 104 to receive a notification of data written at one of the other data centers 102. This written data may be written to a master datastore 106, 108, 110 at that data center 102. As discussed herein, when that data is written, the data center system 104 at that data center 102 may generate a notification that includes the data and an indication of the home data center 102 of the data. Thus, when the notification is received, the home data center 102 of that data may be determined to identify which slave datastore 106, 108, 110 at the local data center 102 corresponds to that home data center.

The instructions stored in the slave datastore updater 720, when executed by the processor(s) 702, may configure the data center system(s) 104 to update slave datastores 106, 108, 110 at the local data center 102 responsive to incoming notifications. The data may then be written to the slave datastore 106, 108, 110 that corresponds to the home data center 102 of the data, where the data was originally stored.

The instructions stored in the data request handler 722, when executed by the processor(s) 702, may configure the data center system(s) 104 to provide data upon request. The incoming request may include a key, such as a Redis key, corresponding to the requested data. According to example embodiments, as disclosed herein, the key may additionally encode an identity of the home data center 102 associated with the data. This is the data center 102 where the data was originally written prior to replication across all of the data centers 102. Therefore, the data center system 104 may use the request and the identifier of the home data center encoded therein to identify a home data center 102 associated with the requested data. It may then identify, based at least in part on the home data center 102, the datastore 106, 108, 110 in which the data is stored. The data may be read from that datastore 106, 108, 110 and presented to the requestor of the data or any other suitable entity.

The illustrated aspects of the claimed subject matter may also be practiced in distributed computing environments where certain tasks are performed by remote processing devices that are linked through a communications network. In a distributed computing environment, program modules can be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A data center system of a first data center, comprising:
one or more processors; and
one or more computer-readable media storing computer-executable instructions that, when executed by the one or more processors, cause the one or more processors to:
receive a first request to store a first data;
store, responsive to the first request, the first data on a first datastore at the first data center;
generate, based at least in part on the first data, a first key corresponding to the first data, the first key comprising an identity of the first data center; and
send, to a second data center system of a second data center, a first indication of the first data associated with the identity of the first data center.

2. The data center system of the first data center of claim 1, wherein the computer-executable instructions further cause the one or more processors to:
send the first key to an entity from which the first request to write the first data is received.

3. The data center system of the first data center of claim 1, wherein the first datastore is a master datastore and a second datastore at the second data center is a slave datastore.

4. The data center system of the first data center of claim 1, wherein the computer-executable instructions further cause the one or more processors to:
receive, from the second data center system, a second indication of a second data written to a second datastore at the second data center;
determine, based at least in part on the second indication, that a third datastore at the first data center corresponds to the second data; and
store the second data on the third datastore.

5. The data center system of the first data center of claim 4, wherein the computer-executable instructions further cause the one or more processors to:
receive a second request to access the second data, the second request comprising a second key;
determine, based at least in part on the second key, that the second data is stored on the third datastore;
read the second data from the third datastore; and
provide the second data.

6. The data center system of the first data center of claim 4, wherein to determine the third datastore at the first data center corresponds to the second data, the computer-executable instructions further cause the one or more processors to:
determine, based at least in part on the second indication, that the second data was received from the second data center system; and
determine that the third datastore corresponds to the second data center system.

7. The data center system of the first data center of claim 4, wherein the computer-executable instructions further cause the one or more processors to:
receive, from a third data center system, a third indication of a third data written to a fourth datastore at a third data center;
determine, based at least in part on the third indication, that the fourth datastore at the first data center corresponds to the third data; and
store the third data on the fourth datastore.

8. The data center system of the first data center claim 1, wherein the computer-executable instructions further cause the one or more processors to:
receive a second request to access the first data, the second request comprising the first key;
determine, based at least in part on the first key, that the first data is stored on the first datastore;
read the first data from the first datastore; and
provide the first data.

9. A computer-implemented method, comprising:
receiving a first request for first data, the first request including a first key;
determining, based at least in part on the first key, that the first data is associated with a first data center;
determining that a first datastore at a second data center is associated with the first data center;
reading the first data from the first datastore; and
providing, responsive to the first request, the first data.

10. The computer-implemented method of claim 9, wherein determining that a first datastore at a second data center is associated with the first data center further comprises:
determining, based at least in part on the first key, an identity of the first data center; and
determining the first data center corresponds to the first datastore.

11. The computer-implemented method of claim 9, wherein the first key is a Redis key including an identifier of the first data center.

12. The computer-implemented method of claim 9, further comprising:
receiving a second request to store a second data;
storing, responsive to the second request, the second data on a second datastore at the second data center; and
generating, based at least in part on the second data, a second key corresponding to the second data, the second key comprising an identity of the second data center.

13. The computer-implemented method of claim 12, further comprising:
sending, to a first data center system of the first data center, an indication of the second data associated with the identity of the second data center.

14. The computer-implemented method of claim 13, further comprising:
sending, to a second data center system of a third data center, the indication of the second data associated with the identity of the second data center.

15. The computer-implemented method of claim 12, further comprising:
receiving a third request to read the second data, the third request including the second key;
determining, based at least in part on the second key, that the second data is stored on the second datastore;
reading the second data from the second datastore; and
providing the second data.

16. A data center system, comprising:
one or more processors; and
one or more computer-readable media storing computer-executable instructions that, when executed by the one or more processors, cause the one or more processors to:
receive a first request for first data, the first request including a first key;
identify a plurality of datastores at a first data center;
determine, based at least in part on the first key, that the first data is associated with a second data center;
determine that a first datastore of the plurality of datastores at the first data center is associated with the second data center;
read, from the first datastore, the first data; and
provide, responsive to the first request, the first data.

17. The data center system of claim 16, wherein the first key is a Redis key including an identifier of the second data center.

18. The data center system of claim 16, wherein the computer-executable instructions further cause the one or more processors to:
receive, from a second data center system of the second data center, an indication of the first data associated with an identifier of the second data center; and
store, based at least in part on the identifier of the second data center, the first data in the first datastore.

19. The data center system of claim 16, wherein the computer-executable instructions further cause the one or more processors to:
receive a second request for second data, the second request including a second key;
determine, based at least in part on the second key, that the second data is associated with a third data center;
determine that a second datastore of the plurality of datastores at the first data center is associated with the third data center;
read, from the second datastore, the second data; and
provide, responsive to the second request, the second data.

20. The data center system of claim 16, wherein the computer-executable instructions further cause the one or more processors to:
receive a second request to store a second data;
store, responsive to the second request, the second data on a second datastore at the first data center; and
send, to a second data center system of the second data center, an indication of the second data associated with an identity of the first data center.
